(19) United States
(12) Patent Application Publication
(10) Pub. No.: US 2010/0171583 A1
(43) Pub. Date: Jul. 8, 2010

(54) BI-DIRECTIONAL BEND RESISTOR

(75) Inventor: John Iovine, Staten Island, NY (US)

Correspondence Address: Workman Nydegger;1000 Eagle Gate Tower, 60 East South Temple, Salt Lake City, UT, 84111, US

(73) Assignee: IMAGES SCIENTIFIC INSTRUMENTS, INC., Staten Island, NY (US)

(21) Appl. No.: 12/503,899

(22) Filed: Jul. 16, 2009

Related U.S. Application Data
(60) Provisional application No. 61/085,052, filed on Jul. 31, 2008.

(51) Int. Cl. H01C 3/06

(52) U.S. Cl. 338/211

(57) ABSTRACT

A system and method for a bi-directional bend resistor are disclosed. The bidirectional deflectable resistor has a variable resistance stack on a top surface of a substrate having a resistance that changes predictably when an electrical signal is applied thereto. The change of resistance of the variable resistance stack reflects an amount of deflection of the bi-directional bend resistor. The variable resistance stack allows for the measurement of deflection of the bi-directional bend resistor in all directions.

### CROSS-REFERENCE TO RELATED APPLICATIONS

The present invention claims the benefit of priority to U.S. Provisional Application No. 61/085,052, filed Jul. 31, 2008, entitled “Bi-Directional Bend Resistor,” the entire content of which is incorporated by reference herein.

### BACKGROUND OF THE INVENTION

1. The Field of the Invention

This invention relates to electrical components and more particularly to deflectable resistors which vary in electrical resistance.

2. Background and Relevant Art

Conductive ink potentiometers are standard elements of electrical and electronic circuits. They are widely in use today for a variety of purposes including the measurement of mechanical movement. For example U.S. Pat. No. 5,157,372 (Langford), U.S. Pat. No. 5,583,476 (Langford), and U.S. Pat. No. 5,086,785 (Gentile et al.), the entire contents of which are incorporated by reference herein, disclose sensors for detecting the angular displacement of an object.

The use of electrically conductive inks in association with electrical or electronic circuitry is also known. For example, U.S. Pat. No. 4,649,784 (Fulks, et al.) discloses the use of a conductive ink which is pressure sensitive to produce electrical switching signals for a keyboard. U.S. Pat. No. 7,277,004 (Beck) uses two layers of conductive material on two opposite surfaces to create a bi-directional bend resistor. This deflectable resistor can only increase electrical resistance in proportion to deflection, regardless of the direction of deflection.

### BRIEF SUMMARY OF THE INVENTION

Implementations of the present invention comprise systems, methods, and apparatus for measuring the direction and amount of deflection of an object. In particular, implementations of the present invention comprise a bi-directional bend resistor capable of producing a consistent and predictable variable electrical output upon deflection or bending between configurations occurring in opposite directions from a static configuration. In at least one implementation, a bi-directional bend resistor include a layer of electrically conductive or resistive material, which both increases and decreases its resistance depending upon the direction of deflection from a nominal (static) position.

For example, an implementation of a bi-directional bend resistor includes a flexible substrate being configured to bend from a static configuration in a first direction. The flexible substrate can also be configured to bend from the static configuration in a second direction opposite to the first direction. The bi-directional bend resistor can also include a variable resistance material disposed on the flexible substrate. The variable resistance material can have a resistance that varies to reflect both the amount of deflection of the flexible substrate, and whether the deflection of the substrate is in the first direction or the second direction.

Furthermore, another implementation of a bi-directional bend resistor can include a flexible substrate having a surface. The bi-directional bend resistor can also include a segmented conductor including a plurality of conductive segments each having a lower surface disposed on the surface of the flexible substrate, and an opposing upper surface. Additionally, the bi-directional bend resistor can have a layer of variable resistance material disposed on the upper surface of one or more of the conductive segments of the segmented conductor and disposed on the top surface of the flexible substrate between the plurality of conductive segments. Also, the resistance of the variable resistance material can change predictably when the flexible substrate is bent.

In addition to the foregoing, an implementation of a method of measuring the amount and direction of deflection of an object can involve placing a bi-directional bend resistor on an object in a first configuration. The bi-directional bend resistor can include a flexible substrate having a surface, and a variable resistance stack disposed on the surface of the flexible substrate. The method can also involve applying an electrical signal to the variable resistance stack when the object is bent from the first configuration to different configuration. Additionally, the method can involve measuring a change of resistance of the variable resistance stack to determine the amount and direction of deflection between the first configuration and the different configuration.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a top view of a bi-directional bend resistor in accordance with an implementation of the present invention;

FIG. 2 illustrates a top perspective view of the bi-directional bend resistor depicted in FIG. 1;

FIG. 3 illustrates an exploded view of the bi-directional bend resistor of FIG. 1 including a substrate, a segmented conductor, and a layer of variable resistance material;

FIG. 4 illustrates a top perspective view of a bi-directional bend resistor deflected from a first configuration in first direction toward a second configuration;

FIG. 5 illustrates a top perspective view of the bi-directional bend resistor of FIG. 4 deflected from a first configuration in a second direction, opposite to the first direction depicted in FIG. 4, toward a third configuration;

FIG. 6A illustrates an enlarged perspective view of a portion of the top of a bi-directional bend resistor in accordance with an implementation of the present invention;

FIG. 6B illustrates an enlarged perspective view of a portion of the top of a bi-directional bend resistor in accordance with another implementation of the present invention;

FIG. 6C illustrates an enlarged perspective view of a portion of the top of a bi-directional bend resistor in accordance with yet another implementation of the present invention;

FIG. 7 is a substantially enlarged cross-section view of a portion of a bi-directional bend resistor of FIG. 6A in a static position;

FIG. 8 is a substantially enlarged cross-section view of a portion of the bi-directional bend resistor of FIG. 6A deflected in a first direction;

FIG. 9 is a substantially enlarged cross-section view of a portion of the bi-directional bend resistor of FIG. 6A deflected in a second direction that is different than the first direction shown in FIG. 9;

FIG. 10 is a side view of a bi-directional bend resistor in various degrees of deflection; and

FIG. 11 shows a graph illustrating the correlation between resistance and deflection degrees illustrated in FIG. 10 for the layer of conductive material on the top surface of a bi-directional bend resistor.

### DETAILED DESCRIPTION OF THE PREFERRED EMBODIMENTS

One or more implementations of the present invention relates to systems, methods, and apparatus for measuring the direction and amount of deflection of an object. In particular, implementations of the present invention comprise a bi-directional bend resistor capable of producing a consistent and predictable variable electrical output upon deflection or bending between configurations occurring in opposite directions from a static configuration. In at least one implementation, a bi-directional bend resistor include a layer of electrically conductive or resistive material, which both increases and decreases its resistance depending upon the direction of deflection from a nominal (static) position.

For example, one or more implementations of the present invention can include a bi-directional bend resistor that can include a substrate having a top surface with a variable resistance stack thereon. The substrate can be bendable in a first direction (away from the top surface of the substrate) to a second configuration relative to a first configuration. The substrate may also be bendable in a second direction, opposite to the first direction, (away from the bottom surface) to a third configuration relative to the first configuration. The variable resistance stack may have a resistance that changes predictably when an electrical signal is applied thereto. The change of resistance of the variable resistance stack may reflect an amount of deflection between the first configuration and the second configuration. In addition, the change of resistance of the variable resistance stack may also reflect an amount of deflection between the first configuration and the third configuration.

In at least one implementation, the variable resistance stack can comprise a layer of variable resistance material and a segmented conductor. For example, the variable resistance stack can include a segmented conductor with the layer of variable resistance material disposed on and in between the individual segments of the segmented conductor. The variable resistance material between the individual segments of the segmented conductor can form a first portion of the layer of variable resistance material, and the variable resistance material deposited on top of the segmented conductor can form a second portion of the layer of variable resistance material.

In one or more implementations, the variable resistance stack may include multiple layers of variable resistance material. Each layer of variable resistive material can include complementary resistive properties such that at least one layer of variable resistance material increases in resistance when the bi-direction bend resistor is deflected in the first direction, and at least a second layer of variable resistance decreases in resistance when the bi-directional bend resistor is deflected in the second direction. The multiple layers of variable resistance material may be placed between the beneath the segments of the segmented conductors, on top of the segments of the segmented conductors, and/or between the segments of the segmented conductor.

In another implementation, the variable resistance stack can include a layer of variable resistance material with a segmented conductor disposed thereon. The variable resistance material directly beneath the segments of the segmented conductor can form a first portion of the layer of variable resistance material. Whereas, the variable resistance material uncovered by the segmented conductor can form a second portion of the layer of variable resistance material.

In any event, a portion of the layer of variable resistance material can increase in resistance when the bi-directional bend resistor is deflected in the first direction (i.e., toward the second configuration or from the first configuration to the second configuration), and the other portion of the layer of variable resistance material can decrease in resistance when the bi-directional bend resistor is deflected in the second direction (i.e., toward the third configuration or from the first configuration to the third configuration). The layer of variable resistance material can have a resistance that changes predictably when the bi-directional bend resistor is bent from the first configuration and an electrical signal is applied thereto. In general, the change of resistance in one portion of the layer of variable resistance material can reflect the amount of deflection in the first direction. The change of resistance in the other portion of the layer of variable resistance material can reflect the amount of deflection in the second direction.

According to at least one implementation of the present invention, the bending of the layer of variable resistance material in the first direction or from the first configuration toward the second configuration can cause a number of micro-cracks added during the manufacturing process to open up and separate in a portion of the layer of variable resistance material. As the amount of bending toward the second configuration increases, the size of the micro-cracks (i.e., the distance between the conductive materials in the layer of variable resistant materials) in the portion of the layer of variable resistance material can increase, and therefore, the resistance can also increase. Similarly, the bending of layer of variable resistance material in the second direction or between the first configuration and the third configuration can cause a number of micro-cracks added during the manufacturing process to close and decrease in separation in the other portion of said layer of variable resistance material. As the amount of bending to the third configuration increases, the size of the micro-cracks in a portion of the layer of variable resistance material can decrease, and therefore, the resistance can also decrease.

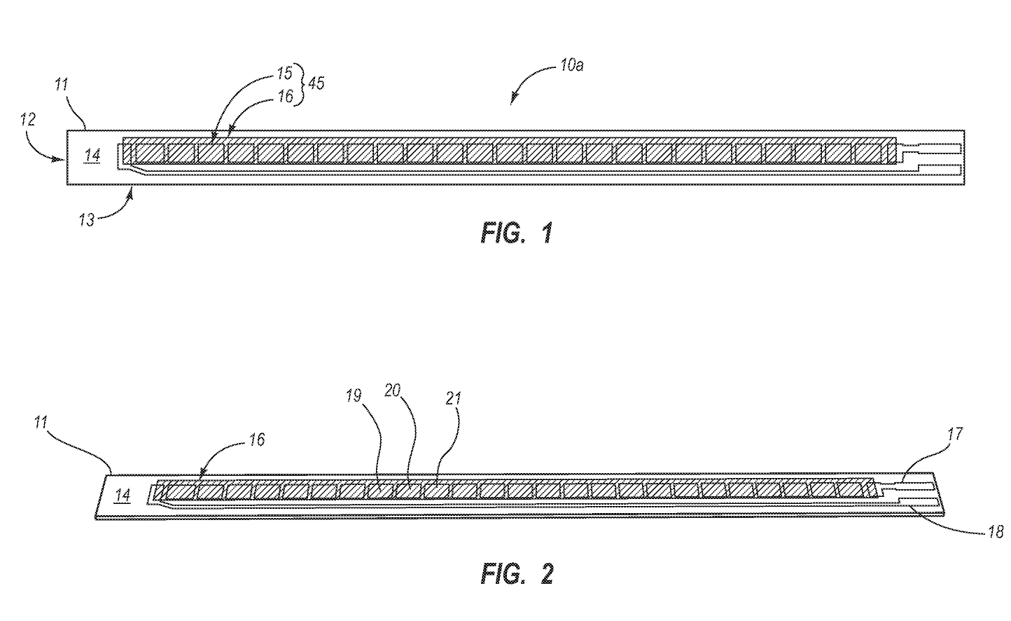

FIG. 1 illustrates a top view of a bi-directional bend resistor 10a in accordance with an implementation of the present invention. Bi-directional bend resistor 10a can comprise a substrate 11. In the illustrated example, substrate 11 has a first length or side 12 and a second length or side 13. A top surface 14 of the deflectable resistor 10 has a variable resistance stack 45 thereon. The variable resistance stack 45 can include a segmented conductor 15 and a layer of variable resistance material 16 disposed thereon.

Substrate 11 may be formed of a deflectable insulating material. Various types of phenolic resin materials are can be suitable for use in the substrate 11. The substrate 11 may also be constructed of various other suitable materials, including various polymers, such as polyamide, polyimide (KAPTON), and polyester (MYLAR), which may be thermoplastics.

For applications involving multiple bending movements, a phenolic resin may be suitable. However, other materials may be suitable in selected applications. For example, the bi-directional deflectable resistor 10a may be used to measure inelastic deformation so that the substrate 11 itself is inelastically deformable. The substrate 11 may be deflectable without causing an electrical discontinuity or open circuit in the conductor means while generally maintaining its electrical insulating characteristics.

The layer of variable resistance material 16 may include a two-part epoxy material, a thermoset adhesive, a thermoplastic, an elastomeric material (rubber, silicon, polymer, etc), or other suitable material, which may incorporate conductive material such as graphite or carbon. The layer of variable resistance material 16 may also include a carbon ruthenium. In at least one implementation, the layer of variable resistance material 16 can comprise a carbon acrylic flexible ink with plasticizers.

For example, the layer of variable resistance material 16 can comprise a conductive carbon ink having 20% by weight carbon, 32% by weight 2-(2-Ethoxyethoxy) ethyl acetate, 32% by weight 2-butoxyethyl acetate, and 16% by weight acrylic resin. Of course one will appreciate in light of the disclosure herein, that this is just one example of a composition for a layer of variable resistance material 16. Other implementations of a layer of variable resistance material 16 can include different weight percentages, different materials, or more or less materials. For example, in at least one implementation, the layer of variable resistance material 16 can include an ink including at least in part epoxy, a polymer carbon, a polyester, an elastomer (e.g., silicon, rubber), or materials that have similar properties.

To attach to a substrate 11 (or segmented conductor 15), the layer of variable resistance material 16 may include a material which facilitates wetting, gluing, or sticking. For example, the layer of variable resistance material 16 may include graphite in combination with a binder. Alternatively or additionally, the layer of variable resistance material 16 may be of the type which is applied to the substrate 11 (or segmented conductor 15) in liquid form and which in turn dries to a solid form.

In at least one implementation, the substrate 11 may be from about 0.003 inches to about 0.015 inches in thickness (although various other thicknesses may be acceptable); the layer of variable resistance material 16 may be from about 0.0006 inches to about 0.0011 inches in thickness (although various other thicknesses may be acceptable).

Bi-directional bend resistor 10a may be used to measure a degree or angle of deflection. The greater the amount of the deflection, the greater or lesser, the resistance of the layer of variable resistance material 16. With measurements, a relationship between the degree or angle of deflection of substrate 11 and the resistance of the layer of variable resistance material 16 may be developed and used in software that is relatively simple to create.

FIG. 2 illustrates a top perspective view of the bi-directional bend resistor 10a in accordance with one implementation of the present invention. The top of the bi-directional bend resistor 10a comprises segmented conductors 19, 20, 21 and a layer of variable resistance material 16 disposed on the top surface 14 of the substrate 11. In the illustrated embodiment, the segmented conductor 15 comprises a number of conductive segments 19, 20, 21 and end conductive segments 17, 18.

Segmented constant-resistance conductive material, although not necessary, may be used in combination with bi-directional bend resistor 10a to reduce the resistance and may help linearize changes in resistance. The conductive segments 17, 18, 19, 20, 21 may be made of copper, copper alloys, silver, silver alloys, or other conductive metals, as well as conductive carbon-based compounds. The conductive segments 17, 18, 19, 20, 21 may be applied in a liquid form, or applied in a solid form which is pressed onto the layer of variable resistance material 16. Additionally, conductive segments 17, 18, 19, 20, 21 may be etched from and comprise, at least in part, a laminate, such as PYRALUX by DUPONT.

The conductivity of the conductive segments 17, 18, 19, 20, 21 may remain essentially constant upon deflection. Therefore, the conductive segments 17, 18, 19, 20, 21 may provide paths for electrical current that are in parallel with the path provided by the layer of variable resistance material 16. Thus, the segmented conductor 15 may act as attenuators and reduce the overall resistance of the conductive stack 45. The segmented conductor 15 may help to make the resistance versus load curve of a bi-directional bend resistor 10a more linear. The segmented conductor 15 may also help make the resistance at a particular deflection configuration more consistently repetitive.

The layer of variable resistance material 16 may be spray painted, rolled, silk screened, or otherwise printed onto the substrate 11. The layer of variable resistance material 16 may be a solid which is pressed onto the substrate 11. According to some implementations of the present invention, a conductive substrate 11 may be used. Also, the substrate 11 may be connected to a particular potential, such as ground. Furthermore, a non-conductive coating may be applied to the substrate 11.

It should be appreciated that, while FIGS. 1-2 depict a rectangular substrate 11 with a layer of variable resistance material 16 on the top surface 14 of the first length or side 12 and second length or side 13, any number of lengths, sides, and shapes may be used.

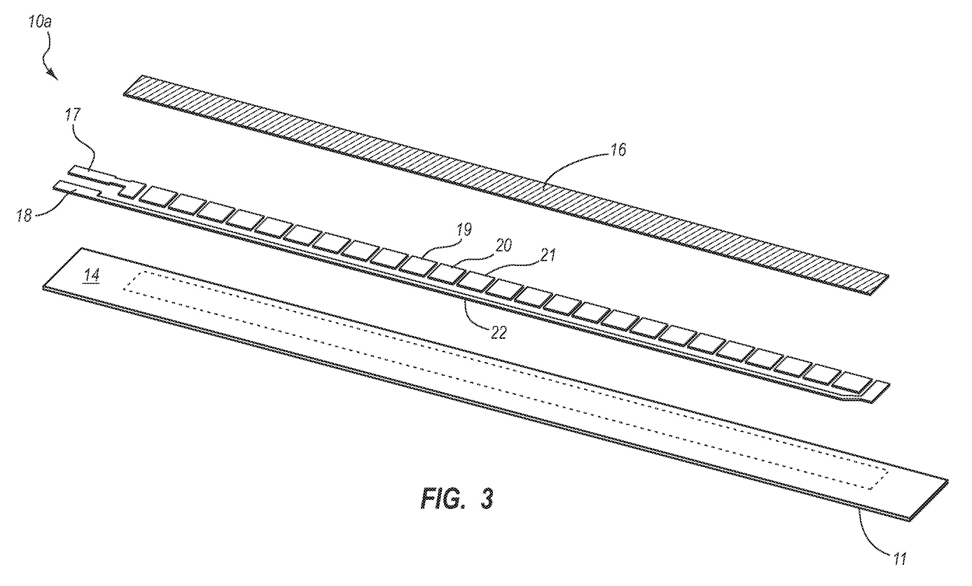

FIG. 3 illustrates an exploded view of a portion of the length or side 12 of substrate 11. As illustrated, the segmented conductor 15 can include conductive segments 19, 20, 21, end conductive segments 17, 18, and a run of conductive material 22 (shown suspended above the substrate 11). The layer of variable resistance material 16 may be disposed on the conductive segments 19, 20, 21, top surface 14, and a portion of the end segment 17.

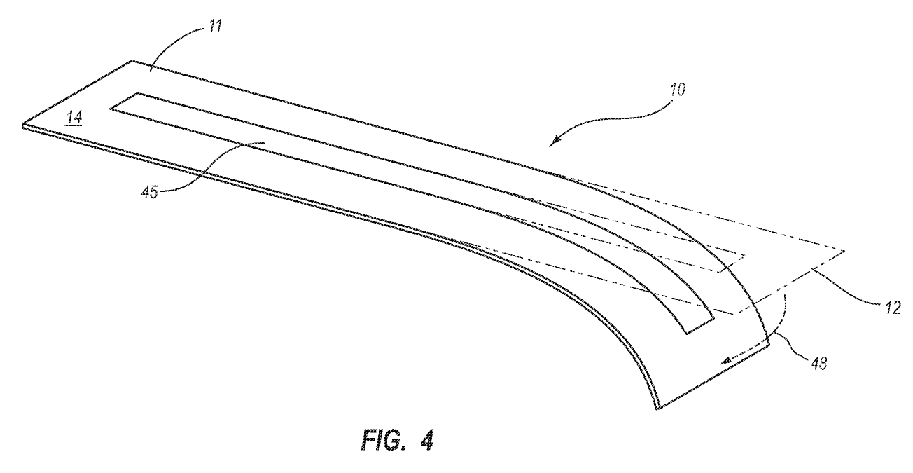

Referring now to FIG. 4, a bi-directional bend resistor 10 is shown that includes a variable resistance stack 45 on the top surface 14 of a substrate 11. FIG. 4 illustrates an end 12 of the bi-directional bend resistor 10 deflecting in a first direction 48 that is generally downward and away relative to the top surface 14 of the substrate 11.

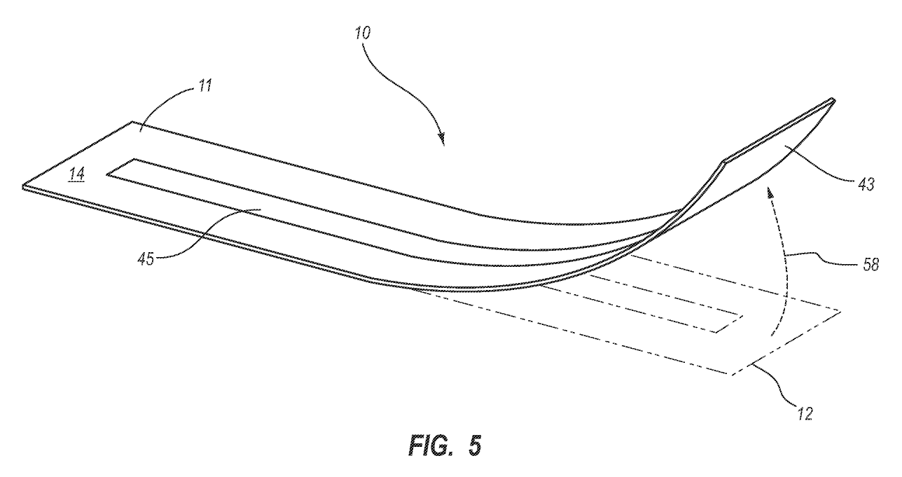

In operation, when the end 12 deflects in the first direction 48, the resistance of the variable resistance stack 45 predictably changes. The measurement of the change of resistance of the layer of variable resistance stack 45 reflects the amount of deflection of the bi-directional bend resistor 10. Referring now to FIG. 5, the bi-directional bend resistor 10 is shown with the end 12 deflecting in a second direction 58 that is generally upward and away relative to the top surface 14 so that the bottom 43 of the substrate 11 is shown, and opposite to the first direction 48 shown in FIG. 4. The measurement of the change of resistance of the variable resistance stack 45 reflects the amount of deflection of the bi-directional bend resistor 10.

Continuing with the operation of the bi-directional bend resistor 10, micro-cracks (not shown) can be added to the layer of variable resistance material 16 during the manufacturing process. As the bi-directional bend resistor (of some or all compositions), is deflected or bent, the distance between the micro-cracks of the layer of variable resistance material 16 can separate, widen, or shorten, depending upon the direction of the deflection. That is, in some or all compositions, the layer of variable resistance material 16 has micro-cracks in a granular or crystalline-type structure, which widen and separate or shorten and close upon deflection and the direction of deflection. As the layer of variable resistance material 16 deflects, the number of cracks and the space between them can increase or decrease, depending upon the direction of the deflection, thereby changing the electrical resistance in a predictable manner. When the bi-directional bend resistor 10 is bent, the change can then be measured upon application of suitable electrical signals.

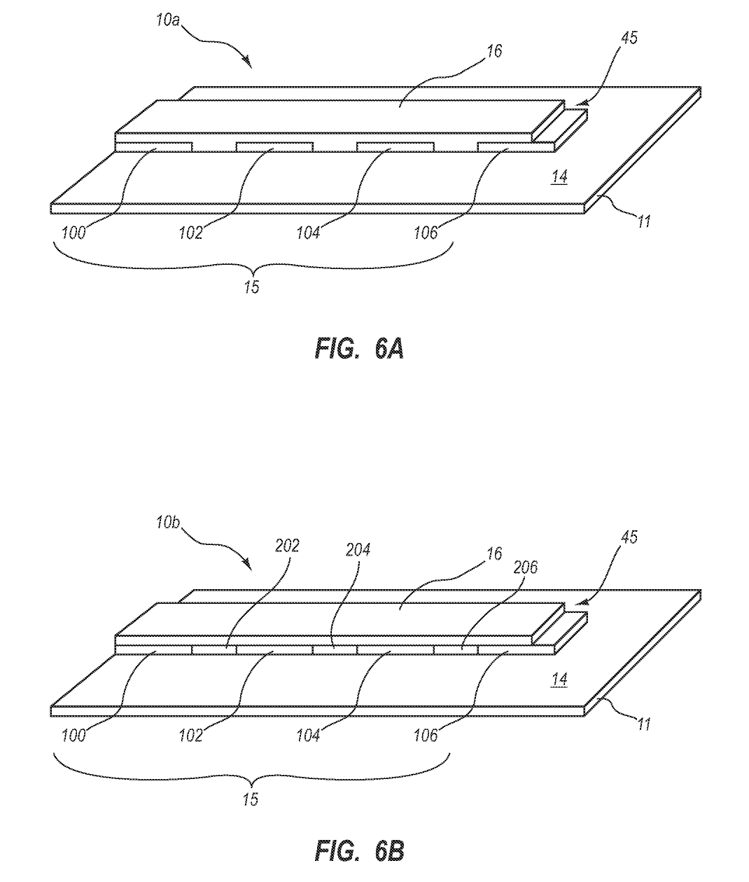

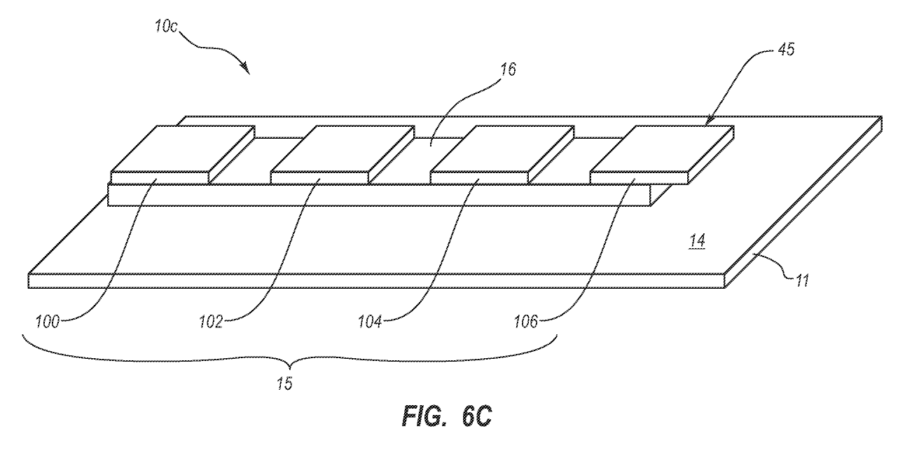

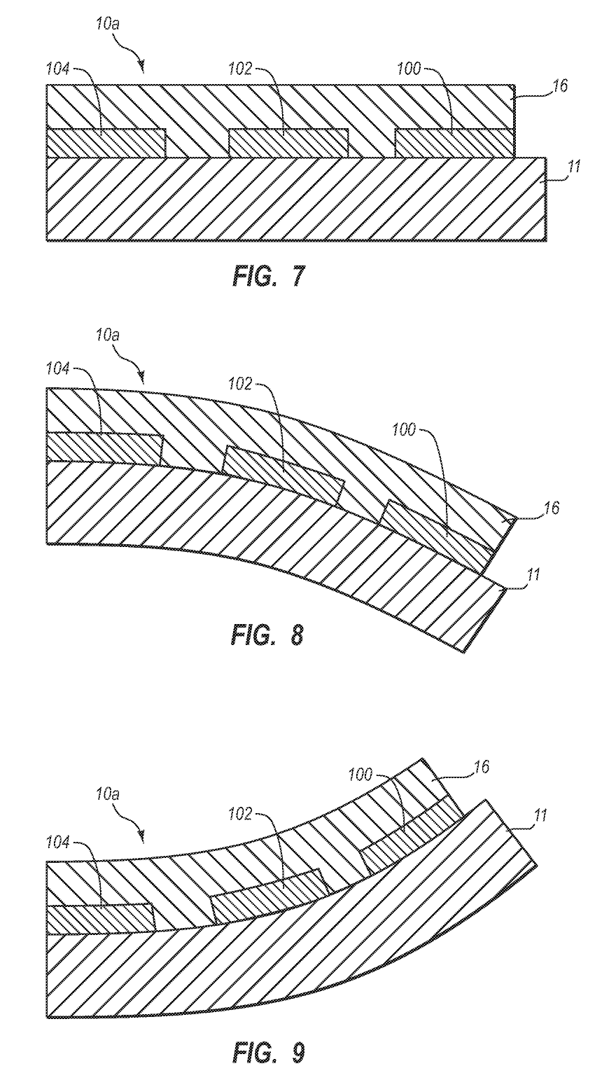

Referring now to FIGS. 6A-6B, three separate implementations of a bi-directional bend resistor 10a, 10b, and 10c are illustrated. Each of the bi-directional bend resistors 10a, 10b, 10c illustrate different implementations of a variable resistance stack 45. As an initial matter, the different layers of the bi-directional bend resistors in FIGS. 6A-6B and similarly in FIGS. 7-9 are not drawn to scale or even proper proportions relative to each other. One will appreciate that, to aid in description, the proportionate thickness of some of the layers has been increased.

For example, the substrate 11 can be elastically deflectable, and have a thickness may from about 0.076 millimeters to about 0.229 millimeters. Alternatively, the substrate 11 can be inelastically deflectable, and the material and thickness can be appropriately selected. The segmented conductor 15 can, in turn, have a thickness which is from about 0.007 millimeters to about 2.0 millimeters, and in at least one implementation about 1.0 millimeters. One will appreciate, however, that various other thicknesses of both the substrate 11 and segmented conductor 15 may be acceptable.

FIG. 6A shows a top view of a portion of a bi-directional bend resistor 10a in perspective and substantially enlarged view. As shown, the variable resistance stack 45 can include a segmented conductor 15 formed of an electrical conductors material in conductive segments 100, 102, 104, 106 that are adhered to the top surface 14 of substrate 11. The variable resistance stack 45 can also include a layer of variable resistance material 16 adhered to the top, sides, and in between the conductive segments 100, 102, 104, 106 of the segmented conductor 15. Also, the portion of the layer of variable resistance material 16 in between the conductive segments 100, 102, 104, 106 can be adhered to the top surface 14 of substrate 11. By adhere, it is meant that the layer of variable resistance material 16 is attached to the substrate 11 or segmented conductor 15 because the layer of variable resistance material 16 includes a material that facilitates wetting, gluing, or sticking.

As illustrated in FIG. 6A, the top surface 14 has a segmented conductor 15 having conductive segments 100, 102, 104, 106 that may be positioned and adhered to the substrate 11. The conductive segments 100, 102, 104, 106 are each spaced apart a preselected distance as shown in FIG. 6A. Notably, the distances may be different (not illustrated); or they may be selected to be substantially the same as shown in FIG. 6A, as desired by the user. The conductive segments 100, 102, 104, 106 can be positioned on the substrate 11, and spaced, to regulate the conductivity and in turn the electrical resistance of the layer of variable resistance material 16, as more specifically discussed herein.

FIG. 6B shows a top view of a portion of a bi-directional bend resistor 10b in perspective and substantially enlarged view. As shown, the variable resistance stack 45 can include a segmented conductor 15 formed of an electrical conductors material in conductive segments 100, 102, 104, 106 that are adhered to the top surface 14 of substrate 11. The variable resistance stack 45 can also include a plurality of inert insulative segments 202, 204, 206 positioned on the substrate 11 between the conductive segments 100, 102, 104, 106 of the segmented conductor 15. The variable resistance stack 45 can also include a layer of variable resistance material 16 adhered to the top of the conductive segments 100, 102, 104, 106 of the segmented conductor 15 and the insulative segments 202, 204, 206.

FIG. 6C shows a top view of a portion of a bi-directional bend resistor 10c in perspective and substantially enlarged view. As shown, the variable resistance stack 45 can include a layer of variable resistance material 16 adhered to the top surface 14 of substrate 11. The variable resistance stack 45 can also include a segmented conductor 15 formed of an electrical conductors material in conductive segments 100, 102, 104, 106 that are adhered to the top of the layer of variable resistance material 16.

In FIGS. 7, 8, and 9, a portion of the bi-directional bend resistor 10a is shown in a first static or non-deflected configuration “A” (FIG. 7), in a bent second configuration “B” (FIG. 8), and a bent third configuration “C” (FIG. 9). The electrical resistance of the bi-directional bend resistor 10a can consistently and predictably vary as the substrate 11 is bent or deflected incrementally to any configuration between configuration “A,” “B,” and “C” as well as other configurations involving greater bending or deflection.

As the bi-directional bend resistor 10a is deflected or bent, the micro-cracks added during manufacturing to the layer of variable resistance material 16, which may contain graphite, may separate and widen when deflected in one direction, and close and shrink when deflected in the opposite direction. That is, the layer of variable resistance material 16 may have a granular or crystalline-type structure with micro-cracks that separate or open up and shrink and close upon deflection and direction of deflection. As the layer of variable resistance material 16 bends, as shown in FIG. 8, the space between the micro-cracks can increase, thereby changing the electrical resistance in a predictable manner. As the layer of variable resistance material 16 bends, as shown in FIG. 9, the space between the micro-cracks can decrease, thereby changing the electrical resistance in a predictable manner. As the bi-directional bend resistor 10a is bent, the change can be measured upon application of suitable electrical signals.

The conductive segments 100, 102, 104 may be positioned underneath the layer of variable resistance material 16 on top surface 14 in pre-selected lengths to control or regulate the resistivity of the deflected layer of variable resistance material 16, and in turn can help ensure that upon repetitive deflections, the variation of the resistance between configurations “A,” “B,” and “C” is substantially consistent throughout the life of the substrate 11. One will appreciate that the conductive segments 100, 102, 104 of the bi-directional bend resistors 10b and 10c of FIGS. 6B and 6C can be similarly configured.

The conductive segments 100, 102, 104, can be formed of copper and silver. Alternatively, they may be formed from conductive silver alloys, and other conductive metals, as well as carbon-based compounds. The conductive segments 100, 102, 104 can retain their electrical conductivity upon deflection.

With the conductive segments 100, 102, 104, affixed or adhered to the substrate 11 and the layer of variable resistance material 16, the resistance may still vary somewhat over time. The degree of variance, however, is either within acceptable tolerances, or otherwise measurable from time to time so that adjustments can be made to accommodate for the drift in resistance over time.

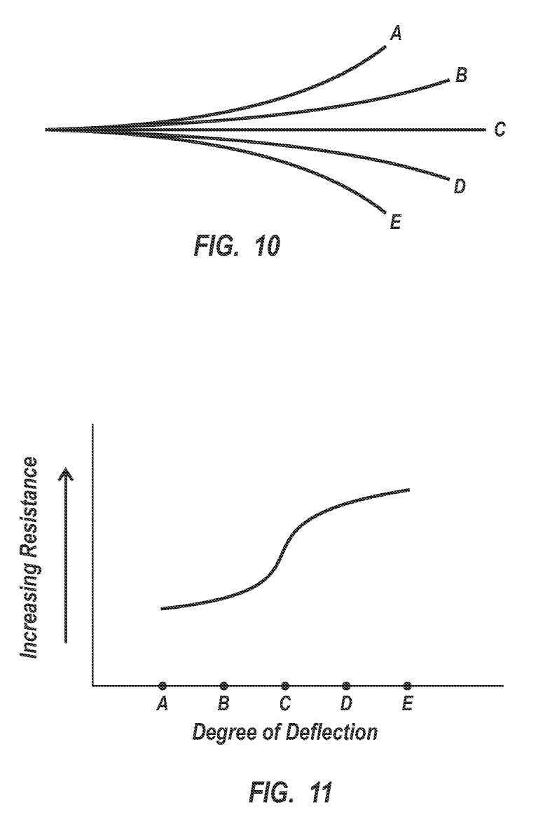

In at least one implementation, the bi-directional bend resistor of the present invention can generate a substantial change in resistance when deflected in both a first direction from a generally straight position, and in a second direction that is in an opposite direction from a generally straight position. For example, FIG. 10 shows a side view of a bi-directional bend resistor at various degrees of deflection, denoted “A,” “B,” “C,” “D,” and “E.” The bi-directional bend resistor can have a substrate on which a variable resistance stack 45 is positioned. Degrees of deflection “D” and “E” are in a first direction and degrees of deflection “A” and “B” are in a second direction.

Generally speaking, position “C” is a static position that is substantially flat or straight relative to an imaginary x-y axis, where the longitudinal y-axis extends the length of bi-directional bend resistor and the x-axis extends upward and downward relative to the top and bottom surface of bi-directional bend resistor. In the illustrated example, deflection degrees “A” and “B” are in a positive x-direction, generally upward and away relative to the top surface, and deflection degrees D and E are in a negative x-direction, generally downward and away relative to the bottom surface and opposite the positive x-direction. In this example, both the positive x-direction and the negative x-direction are relative to the imaginary longitudinal y-axis extending along the length of the substrate of bi-directional bend resistor.

At deflection degree “C,” which is straight, the bi-directional bend resistor has a resistance R.sub.C. At deflection degree “B,” the bi-directional bend resistor has a resistance R.sub.B, which is substantially less than resistance R.sub.C. At deflection degree “B,” the level of resistance R.sub.B is predictable and repeatable. At deflection degree “A,” the bi-directional bend resistor has a resistance R.sub.A, which is substantially less than resistance R.sub.B and is predictable and repeatable. Accordingly, as the deflection changes from degree “C” to degree “B,” there is a predictable and repeatable decrease in resistance.

At deflection degree “D,” the bi-directional bend resistor has a resistance R.sub.D, which is substantially greater than resistance R.sub.C. At deflection degree “D,” the level of resistance R.sub.D is predictable and repeatable. At deflection degree “E,” the bi-directional bend resistor has a resistance R.sub.E, which is substantially greater than resistance R.sub.D and is predictable and repeatable. Accordingly, as the deflection changes from degree “E” to degree “D,” there is a predictable and repeatable decrease in resistance.

FIG. 11 shows a graph illustrating the correlation between resistance and deflection degrees illustrated and explained with respect to FIG. 10 for the layer of variable resistance material 16 of the variable resistance stack 45 of the bi-directional bend resistor.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A bi-directional bend resistor, comprising:
a flexible substrate being configured to bend from a static configuration in a first direction;
the flexible substrate also being configured to bend from the static configuration in a second direction opposite to the first direction; and
a variable resistance stack disposed on the flexible substrate, the variable resistance stack having a resistance that varies to reflect both the amount of deflection of the flexible substrate and whether the deflection of the substrate is in the first direction or the second direction.

2. The bi-directional bend resistor as recited in claim 1, wherein the variable resistance stack comprises a segmented conductor and a layer of variable resistance material.

3. The bi-directional bend resistor as recited in claim 2, wherein the segmented conductor is disposed between a top surface of the flexible substrate and at least a portion of the layer of variable resistance material.

4. The bi-directional bend resistor as recited in claim 2, wherein the layer of variable resistance material is disposed between a top surface of the flexible substrate and at least a portion of the segmented conductor.

5. The bi-directional bend resistor as recited in claim 2, wherein the variable resistance material comprises a conductive ink.

6. The bi-directional bend resistor as recited in claim 4, wherein the variable resistance material comprises graphite or carbon.

7. The bi-directional bend resistor as recited in claim 1, wherein the variable resistance stack has a first resistance when the flexible substrate is in the static configuration.

8. The bi-directional bend resistor as recited in claim 7, wherein the resistance of the variable resistance stack increases from the first resistance as the flexible substrates is bent from the static configuration in the first direction.

9. The bi-directional bend resistor as recited in claim 7, wherein the resistance of the variable resistance stack decreases from the first resistance as the flexible substrates is bent from the static configuration in the second direction.

10. The bi-directional bend resistor as recited in claim 2, further comprising a plurality of micro-cracks formed in the layer of variable resistance material.

11. The bi-directional bend resistor as recited in claim 10, wherein the size of each of the micro-cracks of the plurality of micro-cracks increases as the flexible substrate is bent from the static configuration in the first direction and decreases as the flexible substrate is bent from the static configuration in the second direction.

12. A bi-directional bend resistor, comprising:
a flexible substrate having a surface;
a segmented conductor including a plurality of conductive segments each having a lower surface disposed on the surface of the flexible substrate, and an opposing upper surface; and
a layer of variable resistance material disposed on the upper surface of one or more of the conductive segments of the segmented conductor and disposed on the surface of the flexible substrate between the plurality of conductive segments;
wherein a resistance of the variable resistance material changes predictably when the flexible substrate is bent.

13. The bi-directional bend resistor as recited in claim 12, further comprising a plurality of micro-cracks formed in the layer of variable resistance material.

14. The bi-directional bend resistor as recited in claim 13, wherein the size of the plurality of micro-cracks increases as the flexible substrate is bent in a first direction.

15. The bi-directional bend resistor as recited in claim 14, wherein the resistance of the variable resistance material increases as the size of the plurality of micro-cracks increases.

16. The bi-directional bend resistor as recited in claim 13, wherein the size of the plurality of micro-cracks decreases as the flexible substrate is bent in a second direction opposite to the first direction.

17. The bi-directional bend resistor as recited in claim 16, wherein the resistance of the variable resistance material decreases as the size of the plurality of micro-cracks decreases.

18. A method of measuring the amount and direction of deflection of an object, comprising:
placing a bi-directional bend resistor on an object in a first configuration, the bi-directional bend resistor including a flexible substrate having a surface, and a variable resistance stack disposed on the top surface of the flexible substrate;
applying an electrical signal to the variable resistance stack when the object is bent into a different configuration; and
measuring a change of resistance of the variable resistance stack to determine the amount and direction of deflection between the first configuration and the different configuration.

19. The method as recited in claim 18, determining the direction of deflection between the first configuration and the different configuration is in a first direction upon measuring a negative change in resistance of the variable resistance stack.

20. The system as recited in claim 18, determining the direction of deflection between the first configuration and the different configuration is in a second direction upon measuring a positive change in resistance of the variable resistance stack.
